(19) United States
(12) Patent Application Publication
(10) Pub. No.: US 2006/0221607 A1
(43) Pub. Date: Oct. 5, 2006

(54) Backlight assembly for liquid crystal display

(75) Inventor: Shao-Han Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/397,495

(22) Filed: Apr. 3, 2006

(30) Foreign Application Priority Data
Apr. 1, 2005 (TW) 94205118

(51) Int. Cl. F21V 23/02

(52) U.S. Cl. 362/221

(57) ABSTRACT

A backlight assembly (200) for liquid crystal display includes a plurality of lamps (201), a printed circuit board (203), and a plurality of inverters (202). The lamps are substantially parallel to each other, and each lamp includes two ends. Each end includes an electrode (211). The printed circuit board is disposed at a side of the backlight assembly at corresponding ends of the lamps, for electrically connecting with some or all of the electrodes. The inverter is fixed on the printed circuit board and cooperating with the printed circuit board to provide voltage to drive the lamps. With this configuration, the printed circuit boards and the inverters are arranged at a side of the lamps. Then, the thickness of the backlight assembly is effectively reduced. Therefore, an LCD that employs the backlight assembly can be corresponding thin.

### FIELD OF THE INVENTION

The present invention relates to backlight systems, and more particularly to a backlight assembly for use in liquid crystal display (LCD) devices or the like.

### BACKGROUND

A typical LCD device includes a liquid crystal panel, and a backlight assembly mounted behind the liquid crystal panel for supplying light beams thereto. The backlight assembly is generally categorized as being either of two types—a direct type or an edge-light type—according to the position in which a lamp is installed in the backlight assembly.

In the case of a direct type backlight assembly, the lamp is installed adjacent a rear of the liquid crystal panel. A light spreading plate and a light reflection plate are installed at front and rear portions of the lamp respectively, so that a maximum amount of light beams are output to a liquid crystal panel.

Referring to FIG. 4, a conventional backlight assembly is shown. The backlight assembly 100 includes a plurality of lamps 101, a plurality of inverters 102, a printed circuit board 103, two carriages 104, a reflective plate 105, and a plurality of leads 106. The carriages 104 are oppositely arranged on the reflective plate 105, for supporting two ends of each lamp 101 so that the lamps 101 are spaced above the reflective plate 105. The printed circuit board 103 is arranged below the reflective plate 105, and the inverters 102 are arranged below the printed circuit board 103. The leads 106 electrically connect electrodes of the lamps 101 and the printed circuit board 103.

The printed circuit board 103 and the inverters 102 are arranged in that order below the reflective plate 105. In general, each of the inverters 102 is large in size, and the inverters 102 add to an overall thickness of the backlight assembly 100. This means that an LCD employing the backlight assembly 100 may be unduly thick.

Accordingly, what is needed is a backlight assembly that can overcome the above-described deficiencies.

### SUMMARY

An exemplary backlight assembly for liquid crystal display includes a plurality of lamps, a printed circuit board, and a plurality of inverters. The lamps are substantially parallel to each other, and each lamp includes two ends. Each end includes an electrode. The printed circuit board is disposed at a side of the backlight assembly at corresponding ends of the lamps, for electrically connecting with some or all of the electrodes. The inverters is fixed on the printed circuit board and cooperating with the printed circuit board to providing voltage to drive the lamps.

With this configuration, the printed circuit boards and the inverters are arranged at a side of the lamps. Then, the thickness of the backlight assembly is effectively reduced. Therefore, an LCD that employs the backlight assembly can be corresponding thin.

Other advantages and novel features will become more apparent from the following detailed description when taken in conjunction with the accompanying drawings.

### BRIEF DESCRIPTION OF THE DRAWINGS

FIG. 1 is a schematic, top view of a backlight assembly according to a first embodiment of the present invention.

FIG. 2 is a schematic, top view of a backlight assembly according to a second embodiment of the present invention.

FIG. 3 is a schematic, side view of a backlight assembly according to a third embodiment of the present invention.

FIG. 4 is a schematic, side view of a conventional backlight assembly.

### DETAILED DESCRIPTION OF PREFERRED EMBODIMENTS

Reference will now be made to the drawings to describe the present invention in detail.

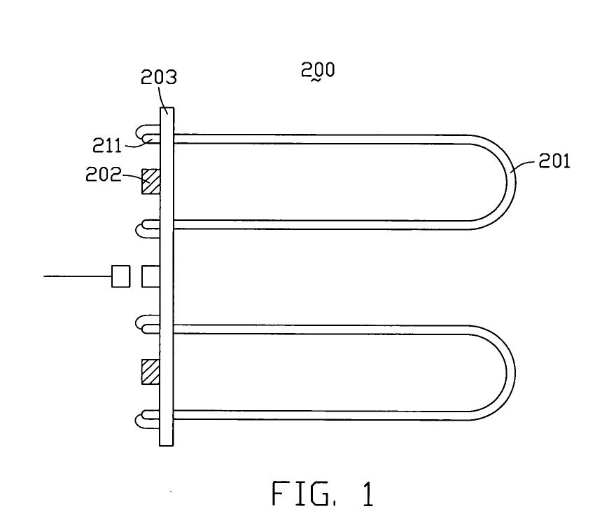

Referring to FIG. 1, a backlight assembly according to a first embodiment of the present invention is shown. The backlight assembly 200 includes a plurality of U-shaped lamps 201, a plurality of inverters 202, and a printed circuit board 203.

Each U-shaped lamp 201 includes two ends (not labeled), and each end of the lamp 201 includes an electrode 211. The lamps 201 are arranged parallel to each other, such that all the electrodes 211 of the lamps 201 are aligned. The printed circuit board 203 is disposed at one side of the backlight assembly 200 at the ends of the lamps 201. The electrodes 211 are mechanically and electrically connected with the printed circuit board 203. The inverters 202 are fixed on the printed circuit board 203, and cooperate with the printed circuit board 203 to provide voltage to drive the lamps 201.

The lamps 201 may be cold cathode fluorescent lamps or like apparatuses. Each of the lamps 201 may further include an insulating cover for protection thereof. The ends of the lamps 201 may directly soldered and electrically connected to the printed circuit board 203. Alternatively, the lamps 201 may be electrically connected to the printed circuit board 203 via leads (not labeled), and then mechanically fixed to the printed circuit board 203.

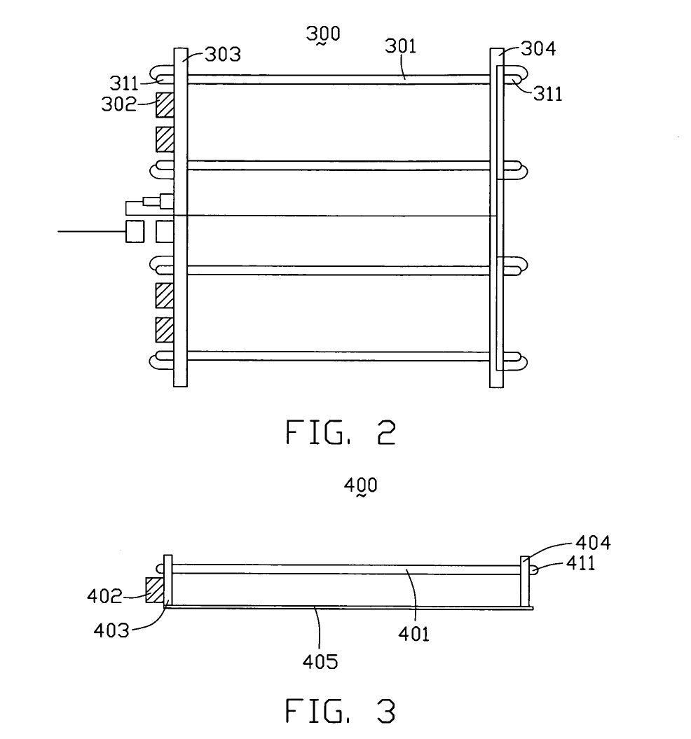

Referring to FIG. 2, a backlight assembly according to a second embodiment of the present invention is shown. The backlight assembly 300 includes a plurality of straight lamps 301, a plurality of inverters 302, a first printed circuit board 303, and a second printed circuit board 304.

The lamps 301 are arranged parallel to each other. Each lamp 301 includes two opposite ends (not labeled), and each end of the lamp 301 includes an electrode 311. The first and second printed circuit boards 303 and 304 are disposed at opposite sides of the backlight assembly 300 at the ends of the lamps 301. The electrodes 311 are electrically connected to the first and second printed circuit boards 303 and 304 respectively via leads (not labeled). The leads of the first and second printed circuit boards 303 and 304 are electrically interconnected via another lead (not labeled). The inverters 302 are fixed on the first printed circuit board 303, and cooperate with the first and second printed circuit boards 303 and 304 to provide voltage to drive the lamps 301.

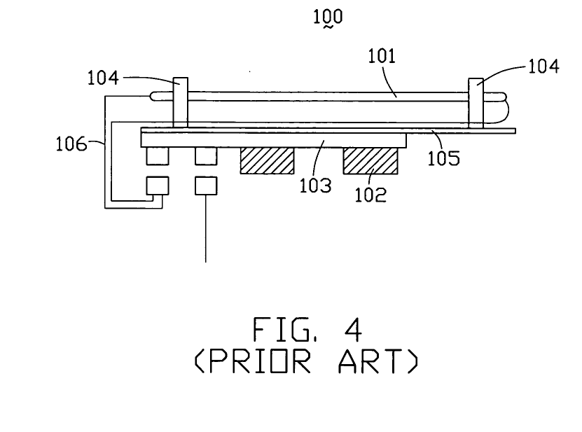

Referring to FIG. 3, a backlight assembly according to a third embodiment of the present invention is shown. The backlight assembly 400 includes a plurality of straight lamps 401, a plurality of inverters 402, a first printed circuit board 403, a second printed circuit board 404, and a bottom plate 405.

The lamps 401 are arranged parallel to each other. Each lamp 401 includes two opposite ends (not labeled), and each end of the lamp 401 includes an electrode 411. The first and second printed circuit boards 403 and 404 are disposed at opposite sides of the backlight assembly 400 at the ends of the lamps 401. The electrodes 411 are electrically connected to the first and second printed circuit boards 403 and 404, respectively. The inverters 402 are fixed on the first printed circuit board 403, and cooperate with the first and second printed circuit boards 403 and 404 to provide voltage to drive the lamps 401. The bottom plate 405 is disposed parallel to and below the lamps 401. The first and second printed circuit boards 403 and 404 are fixed on the bottom plate 405. Thereby, the lamps 401 are supported above the bottom plate 405.

The bottom plate 405 may be a printed circuit board for electrically interconnecting the first and second printed circuit boards 403 and 404. Thereby, the backlight assembly 300 does not require leads. Reflecting materials may be coated at inner surfaces of the bottom plate 405 and the first and second printed circuit boards 403 and 404, for increasing the light utilization efficiency of the backlight assembly 300.

For controlling the thickness of the backlight assembly, it is preferred to use the inverters that has a size smaller than that of the backlight assembly.

Various modifications and alterations are possible within the ambit of the invention herein. For example, the inverters may be arranged on both of oppositely disposed printed circuit boards.

In the first embodiment, the printed circuit board 203 and the inverters 202 are arranged at a side of the lamps 201. In the second and third embodiments, the printed circuit boards 303, 304, 403, 404 are arranged at sides of the lamps 301, 401, and the inverters 302, 402 are arranged at one of the sides of the lamps 301, 401. With these kinds of configurations, the thickness of the backlight assembly is effectively reduced. Therefore an LCD that employs the backlight assembly can be correspondingly thin.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight assembly for a liquid crystal display, comprising:
a plurality of lamps substantially parallel to each other, each lamp comprising two ends, each end comprising an electrode;
a first printed circuit board disposed at a side of the backlight assembly at corresponding ends of the lamps, for electrically connecting with some or all of the electrodes; and
at least one inverter fixed on the first printed circuit board for cooperating with the first printed circuit board to provide voltage to drive the lamps.

2. The backlight assembly as claimed in claim 1, wherein the lamps are U-shaped.

3. The backlight assembly as claimed in claim 1, wherein the electrodes of the lamps are soldered to the first printed circuit board.

4. The backlight assembly as claimed in claim 1, further comprising a second printed circuit board disposed at another side of the backlight assembly opposite to the first printed circuit board at corresponding ends of the lamps.

5. The backlight assembly as claimed in claim 4, wherein the lamps are straight, and corresponding of the electrodes of the lamps are fixed on the second printed circuit board.

6. The backlight assembly as claimed in claim 5, further comprising at least one inverter fixed on the second printed circuit board for cooperating with the second printed circuit board to provide voltage to drive the lamps.

7. The backlight assembly as claimed in claim 4, wherein the first and second printed circuit boards are electrically interconnected via at least one lead.

8. The backlight assembly as claimed in claim 4, further comprising a bottom plate for supporting the first and second printed circuit boards.

9. The backlight assembly as claimed in claim 8, wherein the bottom plate electrically interconnects the first and second printed circuit boards.

10. The backlight assembly as claimed in claim 8, further comprising reflective material coated on an inner surface of any one or more items selected from the group consisting of the bottom plate, the first printed circuit board, and the second printed circuit board.

11. The backlight assembly as claimed in claim 8, wherein the bottom plate is a third printed circuit board.

12. A backlight assembly for a liquid crystal display, comprising:
at least one lamp substantially extending along a longitudinal direction, said at least one lamp defining two opposite electrodes at two opposite ends, respectively;
a printed circuit board disposed at a side of the backlight assembly and extending in a plane under a non-parallel relation with regard to said longitudinal direction, at least one of said two opposite electrodes mechanically and electrically connected to said printed circuit board; and
at least one inverter fixed on one face of the printed circuit board for cooperating with the first printed circuit board to provide voltage to drive the lamps, while said at least one lamp essentially extends on the other face of the printed circuit board.

13. The backlight assembly as claimed in claim 12, wherein said plane is perpendicular to said longitudinal direction.

14. The backlight assembly as claimed in claim 12, wherein the opposite ends of the lamp are spaced from each other along said longitudinal direction.

15. The backlight assembly as claimed in claim 12, wherein the opposite ends of the lamp are spaced from each other in a direction extending along said plane.

16. The backlight assembly as claimed in claim 14, wherein another printed circuit board is mechanically and electrically connected to the other of said electrodes.

17. The backlight assembly as claimed in claim 16, wherein said another printed circuit board extends in another plane spaced from said plane and under a non-parallel relation with regard to said longitudinal direction.
